(19) United States
(12) Patent Application Publication
(10) Pub. No.: US 2019/0305362 A1
(43) Pub. Date: Oct. 3, 2019

(54) ELECTRODE MATERIAL FOR LITHIUM ION SECONDARY BATTERY, ELECTRODE FOR LITHIUM ION SECONDARY BATTERY, AND LITHIUM ION SECONDARY BATTERY

(71) Applicant: SUMITOMO OSAKA CEMENT CO., LTD., Tokyo (JP)

(72) Inventors: Tsutomu NOZOE, Tokyo (JP); Ryuuta YAMAYA, Tokyo (JP)

(21) Appl. No.: 16/139,613

(22) Filed: Sep. 24, 2018

(30) Foreign Application Priority Data
Mar. 29, 2018 (JP) 2018-064426

(51) Int. Cl. H01M 10/0525; H01M 4/66; H01M 10/04

(52) U.S. Cl. CPC H01M 10/0525; H01M 10/0431; H01M 4/666

(57) ABSTRACT

An electrode material for a lithium ion secondary battery of the present invention is an electrode material for a lithium ion secondary battery containing a granulated body which is generated from primary particles, wherein the primary particles include an olivine-type electrode active material and a carbonaceous film that coats a surface of the olivine-type electrode active material, in which an average particle diameter of the primary particles is 30 nm or more and 500 nm or less, an average particle diameter of the granulated body is 0.5 μm or more and 60 μm or less, a tensile strength σ of the granulated body is 4 MPa or more, and a brittleness of the granulated body that is defined as a ratio (σ/b) of the tensile strength σ of the granulated body to a compression constant b of the granulated body is 0.2 or more.

### TECHNICAL FIELD

The present invention relates to an electrode material for a lithium ion secondary battery, an electrode for a lithium ion secondary battery, and a lithium ion secondary battery.

### BACKGROUND ART

Lithium ion secondary batteries that are non-aqueous electrolyte-based secondary batteries are capable of size reduction, weight reduction, and a capacity increase and, furthermore, have excellent characteristics such as a high output and a high energy density and are thus commercialized as a high-output power supply for electric vehicles, electric tools, and the like, and active development of electrode materials for a next-generation lithium ion secondary battery is underway across the globe. As the electrode materials for a lithium ion secondary battery, for example, an electrode material containing a granulated body granulated by primary particles including an electrode active material and a carbonaceous film that coats a surface of the electrode active material is known.

In the case of preparing an electrode material paste containing a granule of an electrode active material, there is a case in which the granule of the electrode active material breaks due to a shear force of kneading during the kneading of lithium iron phosphate and a binder. When the granule of the electrode active material breaks, fragments of the granule are generated. When a carbonaceous film that coats a surface of the granule of the electrode active material is damaged by the fragments, there is a case in which the carbonaceous film peels off from the granule. In such a case, electron conductivity of an electrode material for a lithium ion secondary battery decreases. In addition, in a case in which the electrode material paste containing the granule of the electrode active material is applied onto a current collector to form a coated film, and the coated film is bonded by pressurization to flatten the coated film, there is a case in which the granule of the electrode active material fails to withstand the pressure and cracks. When the granule of the electrode active material cracks, the carbonaceous film that coats the surface of the granule peels off, and, consequently, the electron conductivity of the electrode material for a lithium ion secondary battery decreases. In addition, the granule of the electrode active material is poorly resistant to deformation. Therefore, there has been a case in which the granule cracks when receiving an impact in spite of the high compressive strength.

As an electrode material regulating the compressive strength, for example, an electrode material including electrode active material particles made of a lithium phosphate compound and a carbonaceous material that coats the electrode active material particles and bonds the electrode active material particles, in which, in a case in which an agglomerated body including the electrode active material particles and the carbonaceous material is produced by agglomerating a plurality of the electrode active material particles, an average compressive strength of the agglomerated body is set to 0.05 kgf/mm² or more and 2.0 kgf/mm² or less is known (for example, refer to Patent Document 1).

### RELATED ART DOCUMENT

### Patent Document

Patent Document 1: Japanese Laid-open Patent Publication No. 2014-060142

### DISCLOSURE OF THE INVENTION

### Problem that the Invention is to Solve

However, the invention described in Patent Document intends to provide an electrode material which is capable of improving both a density and an electron conductivity of an electrode active material layer, thus, capable of improving charge and discharge performance of an electrode, and, furthermore, capable of increasing a battery capacity. Therefore, from the invention described in Patent Document 1, a sufficient effect cannot be obtained regarding the object of improving the compressive strength and the tensile strength of the granule of the electrode active material.

The present invention has been made in consideration of the above-described circumstances, and an object of the present invention is to provide an electrode material for a lithium ion secondary battery having an improved compressive strength and an improved tensile strength, an electrode for a lithium ion secondary battery containing the electrode material for a lithium ion secondary battery, and a lithium ion secondary battery including the electrode for a lithium ion secondary battery.

### Means for Solving the Problem

As a result of intensive studies for solving the above-described problem, the present inventors found that, when an electrode material for a lithium ion secondary battery is a material which contains a granulated body, which is granulated from primary particles which include an olivine-type electrode active material and a carbonaceous film that coats a surface of the olivine-type electrode active material, wherein an average particle diameter of the primary particles is 30 nm or more and 500 nm or less, an average particle diameter of the granulated body is 0.5 μm or more and 60 μm or less, a tensile strength σ of the granulated body is 4 MPa or more, and a brittleness of the granulated body that is defined as a ratio (σ/b) of the tensile strength σ of the granulated body to a compression constant b of the granulated body is set to 0.2 or more, a compressive strength and a tensile strength of the electrode material for a lithium ion secondary battery improve, consequently, breakage of the electrode material for a lithium ion secondary battery due to an external force is suppressed, and it is possible to prevent the peeling of the carbonaceous film that coats the surface of the olivine-type electrode active material and completed the present invention.

An electrode material for a lithium ion secondary battery of the present invention is an electrode material for a lithium ion secondary battery containing a granulated body which is generated from primary particles, wherein the primary particles include an olivine-type electrode active material and a carbonaceous film that coats a surface of the olivine-type electrode active material, in which an average particle diameter of the primary particles is 30 nm or more and 500 nm or less, an average particle diameter of the granulated body is 0.5 μm or more and 60 μm or less, a tensile strength σ of the granulated body is 4 MPa or more, and a brittleness of the granulated body that is defined as a ratio (σ/b) of the tensile strength σ of the granulated body to a compression constant b of the granulated body is 0.2 or more.

An electrode for a lithium ion secondary battery of the present invention is an electrode for a lithium ion secondary battery including an electrode current collector and an electrode mixture layer formed on the electrode current collector, in which the electrode mixture layer contains the electrode material for a lithium ion secondary battery of the present invention.

A lithium ion secondary battery of the present invention is a lithium ion secondary battery having a cathode, an anode, and a non-aqueous electrolyte, in which the cathode is the electrode for a lithium ion secondary battery of the present invention.

The electrode material preferably consists of the granulated body, and the granulated body preferably consists of an aggregate, an assembly, or a gathering of the primary particles.

### Advantage of the Invention

According to the electrode material for a lithium ion secondary battery of the present invention, it is possible to provide an electrode material for a lithium ion secondary battery having an improved compressive strength and an improved tensile strength.

According to the electrode for a lithium ion secondary battery of the present invention, the electrode material for a lithium ion secondary battery of the present invention is contained, and thus it is possible to provide an electrode for a lithium ion secondary battery capable of producing an electrode having excellent electron conductivity.

According to the lithium ion secondary battery of the present invention, the electrode for a lithium ion secondary battery of the present invention is provided, and thus it is possible to provide a lithium ion secondary battery having a large discharge capacity.

### BEST MODE FOR CARRYING OUT THE INVENTION

An embodiment of an electrode material for a lithium ion secondary battery, an electrode for a lithium ion secondary battery, and a lithium ion secondary battery of the present invention will be described.

Meanwhile, the present embodiment is specific description for the better understanding of a gist of the invention and, unless particularly otherwise described, does not limit the present invention.

[Electrode Material for Lithium Ion Secondary Battery]

The electrode material for a lithium ion secondary battery of the present embodiment is an electrode material for a lithium ion secondary battery containing a granulated body granulated by primary particles which include an olivine-type electrode active material and a carbonaceous film that coats a surface of the olivine-type electrode active material, in which an average particle diameter of the primary particles is 30 nm or more and 500 nm or less, an average particle diameter of the granulated body is 0.5 μm or more and 60 μm or less, a tensile strength σ of the granulated body is 4 MPa or more, and a brittleness of the granulated body that is defined as a ratio (σ/b) of the tensile strength σ of the granulated body to a compression constant b of the granulated body is 0.2 or more.

The electrode material for a lithium ion secondary battery of the present embodiment includes a granulated body granulated by primary particles which include an olivine-type electrode active material (primary particles) and a carbonaceous film that coats a surface of the olivine-type electrode active material. Hereinafter, the olivine-type electrode active material (primary particles) and primary particles including the carbonaceous film that coats the surface of the olivine-type electrode active material will also be referred to as primary particles of the carbonaceous coated electrode active material in some cases.

In the electrode material for a lithium ion secondary battery of the present embodiment, an average particle diameter of the primary particles of the carbonaceous coated electrode active material is 30 nm or more and 500 nm or less, preferably 50 nm or more and 400 nm or less, and more preferably 50 nm or more and 300 nm or less.

Here, the reasons for setting the average particle diameter of the primary particles of the carbonaceous coated electrode active material in the above-described range are as described below. When the average primary particle diameter is 30 nm or more, it is possible to suppress an increase in an amount of carbon caused by a specific surface area becoming excessively large. Meanwhile, when the average primary particle diameter is 500 nm or less, it is possible to improve electron conductivity and ion diffusivity due to a size of the specific surface area.

The average particle diameter of the primary particles of the carbonaceous coated electrode active material can be obtained by number-averaging the particle diameters of 200 or more primary particles randomly measured using a scanning electron microscope (SEM).

In the electrode material for a lithium ion secondary battery of the present embodiment, an average particle diameter of the granulated body granulated by the primary particles of the carbonaceous coated electrode active material is 0.5 μm or more and 60 μm or less, preferably 1 μm or more and 20 μm or less, and more preferably 1 μm or more and 10 μm or less.

Here, the reasons for setting the average particle diameter of the granulated body in the above-described range are as described below. When the average particle diameter of the granulated body is 0.5 μm or more, it is possible to suppress an amount of a conductive auxiliary agent and the binding agent blended to prepare an electrode material paste for a lithium ion secondary battery by mixing the electrode material, the conductive auxiliary agent, the binder resin (the binding agent), and a solvent and increase a battery capacity of a lithium ion secondary battery per unit mass of a cathode mixture layer for a lithium ion secondary battery. Meanwhile, when the average particle diameter of the granulated body is 60 μm or less, it is possible to enhance the dispersibility and uniformity of the conductive auxiliary agent or the binding agent included in the cathode mixture layer. As a result, the lithium ion secondary battery in which the electrode material for a lithium ion secondary battery of the present embodiment is used is capable of increasing the discharge capacities in high-speed charge and discharge.

The average particle diameter of the granulated body is measured using a laser diffraction/scattering particle size distribution analyzer by suspending the electrode material for a lithium ion secondary battery of the present embodiment in a dispersion medium obtained by dissolving 0.1% by mass of polyvinyl pyrrolidone in water.

In the electrode material for a lithium ion secondary battery of the present embodiment, a tensile strength σ of the granulated body is 4 MPa or more, preferably 4.2 MPa or more, and more preferably 4.5 MPa or more. In addition, an upper limit of the tensile strength σ of the granulated body may be 20 MPa or less, may be 15 MPa or less, and may be 10 MPa or less.

Here, the reasons for setting the tensile strength σ of the granulated body in the above-described range are as described below. When the tensile strength σ of the granulated body is less than 4 MPa, the granulated body breaks due to a force being applied when the electrode material is pressurized in order to improve adhesiveness between the electrode material and a current collector after application of the electrode material paste containing the granulated body to the current collector.

In the electrode material for a lithium ion secondary battery of the present embodiment, a method for measuring the tensile strength of the granulated body is as described below.

The particle diameter of the electrode material is measured in a microscope using a micro compression tester (trade name: MCT510, manufactured by Shimadzu Corporation), and then a fracture strain is measured in a compression test mode under conditions of a kind of an indenter: FLAT50, a load rate: 0.0446 mN/sec, and a testing force: 9.8 mN. Meanwhile, in the measurement, five granulated bodies are randomly selected as specimens, an average value of strain is calculated from particle diameters of the five specimens and a variation of the particle diameters when the granulated bodies fracture, and the obtained value is considered as the fracture strain.

3 g of the granulated body is injected into a mold (a recess portion having a circular shape with a diameter of 2 cm in the case of being seen in a plane), a pressure is applied thereto at intervals of 0.5 MPa, and a total of the pressure applied up to 3 MPa and a volume change in the electrode material are measured. That is, the pressure being applied is increased at 0.5 MPa intervals such as 0 MPa, 0.5 MPa, 1.0 MPa, 1.5 MPa, 2.0 MPa, 2.5 MPa, and 3.0 MPa, and volumes at the respective pressures are measured. From those values, the tensile strength and the brittleness of the granulated body are calculated using Expressions (1) to (3).

In Expressions (1) to (3), V₀ represents a volume (m³) of the electrode material before compression, V represents the volume (m³) of the electrode material under compression, Vₘ represents the volume (a volume with a porosity of zero and equivalent to a true specific weight) (m³) of the electrode material itself, P represents a compressive pressure (MPa), yc represents the fracture strain of the granulated body, ε₀ represents a porosity before compression (ε₀=1−Vₘ/V₀) ε represents a porosity under compression (ε=1−Vₘ/V), ε_{c} represents a porosity at the fracture of the granulated body (ε₀=1−1/(1−yc)3×(1−ε₀)), a represents the tensile strength (MPa), b represents a compression constant (MPa), and C represents the brittleness (C=σ/b).

Xa=(ε₀−ε)/(ε₀−ε₀) (1)

Xb=(V₀−V)/Vₘ (2)

Y=P×(V−Vₘ)/Vₘ (3)

A slope in a case in which Xa is plotted along a horizontal axis and Y is plotted along a vertical axis is σ/0.9, and the slope in a case in which Xb is plotted along the horizontal axis and Y is plotted along the vertical axis is b.

In the electrode material for a lithium ion secondary battery of the present embodiment, the compression constant b of the granulated body is preferably 8 MPa or more, more preferably 12 MPa or more, and still more preferably 16 MPa or more.

When the compression constant b of the granulated body is less than 8 MPa, pores are generated between the granulated body and the conductive auxiliary agent or the binding agent due to deformation in the case of applying the electrode material paste to the current collector, a resistance of the electrode increases, and battery characteristics degrade.

In the electrode material for a lithium ion secondary battery of the present embodiment, the compression constant of the granulated body refers to a numerical value at which σₘ=0.9b is reached with respect to the tensile strength σₘ in a case in which it is assumed that the porosity ε_{c} at the fracture of the granulated body is zero, that is, the granulated body is not fractured until pores disappear. Therefore, an upper limit of the compression constant b changes depending on the tensile strength.

In the electrode material for a lithium ion secondary battery of the present embodiment, the brittleness of the granulated body that is defined as a ratio (σ/b) of the tensile strength σ of the granulated body to the compression constant b of the granulated body is 0.2 or more, preferably 0.21 or more, and more preferably 0.22 or more. In addition, an upper limit of the brittleness of the granulated body may be 0.90 or less, may be 0.52 or less, and may be 0.30 or less.

Here, the reasons for setting the brittleness of the granulated body in the above-described range are as described below. When the brittleness of the granulated body is less than 0.2, a disadvantage of a surface layer portion being easily broken when an impact is applied to the granulated body is likely to be caused. The carbonaceous film peels off due to fragments generated by the breakage, and the electrode characteristics degrade.

In the electrode material for a lithium ion secondary battery of the present embodiment, the reason for defining the brittleness of the granulated body as the ratio (σ/b) of the tensile strength σ of the granulated body to the compression constant b of the granulated body is that the compression constant b is a numerical value correlating with the tensile strength σₘ in a case in which it is assumed that the granulated body is not fractured due to deformation and the fact that, as the ratio of the tensile strength σ to the compression constant b calculated by measurement becomes closer to 0.9, the breakage of the granulated body due to deformation or the application of an impact to the granulated body becomes more difficult is indicated.

In the electrode material for a lithium ion secondary battery of the present embodiment, a content of carbon in the granulated body is preferably 0.5% by mass or more and 2.5% by mass or less, more preferably 0.8% by mass or more and 1.3% by mass or less, and still more preferably 0.8% by mass or more and 1.2% by mass or less.

Here, the reasons for setting the content of carbon in the granulated body in the above-described range are as described below. When the content of carbon in the primary particles is 0.5% by mass or more, it is possible to sufficiently enhance the electron conductivity. Meanwhile, when the content of carbon in the granulated body is 2.5% by mass or less, it is possible to increase the electrode density.

The content of carbon in the granulated body is measured using a carbon analyzer (carbon/sulfur combustion analyzer: EMIA-810W (trade name) manufactured by Horiba Ltd.).

In the electrode material for a lithium ion secondary battery of the present embodiment, a coating ratio of the carbonaceous film to the primary particles of the carbonaceous coated electrode active material is preferably 80% or more, more preferably 85% or more, and still more preferably 90% by mass or more.

Here, the reasons for setting the coating ratio of the carbonaceous film to the primary particles of the carbonaceous coated electrode active material in the above-described range are as described below. When the coating ratio of the carbonaceous film to the primary particles of the carbonaceous coated electrode active material is 80% or more, a coating effect of the carbonaceous film can be sufficiently obtained.

The coating ratio of the carbonaceous film to the primary particles of the carbonaceous coated electrode active material is measured using a transmission electron microscope (TEM), an energy dispersive X-ray microanalyzer (EDX), or the like.

In the electrode material for a lithium ion secondary battery of the present embodiment, a film thickness of the carbonaceous film in the primary particles of the carbonaceous coated electrode active material is preferably 0.8 nm or more and 5.0 nm or less, more preferably 0.9 nm or more and 4.5 nm or less, and still more preferably 0.8 nm or more and 4.0 nm or less.

Here, the reasons for setting the film thickness of the carbonaceous film in the primary particles of the carbonaceous coated electrode active material in the above-described range are as described below. When the film thickness of the carbonaceous film in the primary particles is 0.8 nm or more, it is possible to suppress the formation of a carbonaceous film having a desired resistance value becoming impossible due to an excessively small thickness of the carbonaceous film. Meanwhile, when the film thickness of the carbonaceous film in the primary particles of the carbonaceous coated electrode active material is 5.0 nm or less, it is possible to suppress a decrease in the battery capacity of the electrode material per unit mass.

The film thickness of the carbonaceous film in the primary particles of the carbonaceous coated electrode active material is measured using a transmission electron microscope (TEM), an energy dispersive X-ray microanalyzer (EDX), or the like.

In the electrode material for a lithium ion secondary battery of the present embodiment, an oil absorption amount of the granulated body using N-methyl-2-pyrrolidone (NMP) is preferably 50 ml/100 g or less, more preferably 48 ml/100 g or less, and still more preferably 45 ml/100 g or less.

Here, the reasons for setting the oil absorption amount of the granulated body using N-methyl-2-pyrrolidone in the above-described range are as described below. When the oil absorption amount of the granulated body using N-methyl-2-pyrrolidone is 50 ml/100 g or less, it is possible to suppress an increase in a viscosity of the electrode material paste, and the dispersion of the conductive auxiliary agent or the binding agent becomes easy.

Meanwhile, in the electrode material for a lithium ion secondary battery of the present embodiment, the oil absorption amount of the olivine-type electrode active material using N-methyl-2-pyrrolidone is measured according to a method described in JIS K5101-13-1 (Test methods for pigments—Part 13: Oil absorption—Section 1: Refined linseed oil method) using linseed oil instead of NMP.

The specific surface area of the granulated body of the electrode material for a lithium ion secondary battery of the present embodiment is preferably 6 m²/g or more and 30 m²/g or less and more preferably 10 m²/g or more and 20 m²/g or less.

Here, the reasons for setting the specific surface area of the electrode material for a lithium ion secondary battery of the present embodiment in the above-described range are as described below. When the specific surface area is 6 m²/g or more, it is possible to increase a diffusion rate of a lithium ion in the electrode material, and it is possible to improve the battery characteristics of the lithium ion secondary battery. Meanwhile, when the specific surface area is 30 m²/g or less, it is possible to increase the electron conductivity.

The specific surface area of the electrode material for a lithium ion secondary battery of the present embodiment is measured using a specific surface area meter and a BET method by means of nitrogen (N₂) adsorption.

A green compact resistance of the electrode material for a lithium ion secondary battery of the present embodiment is preferably 1 MΩ·cm or less and more preferably 3 kΩ·cm or less.

Here, the reasons for setting the green compact resistance of the electrode material for a lithium ion secondary battery of the present embodiment in the above-described range are as described below. When the green compact resistance is 1 MΩ·cm or less, it is possible to increase the discharge capacity at a high charge-discharge rate in the case of forming a battery.

“Olivine-Type Electrode Active Material”

As the olivine-type electrode active material, a compound represented by General Formula LiₓA_{y}D_{z}PO₄ (here, A represents at least one element selected from the group consisting of Co, Mn, Ni, Fe, Cu, and Cr, D represents at least one element selected from the group consisting of Mg, Ca, Sr, Ba, Ti, Zn, B, Al, Ga, In, Si, Ge, Sc, and Y, 0.9<x<1.1, 0<y≤1, 0≤z<1, and 0.9<y+z<1.1), LiFePO₄, MgFeSiO₄, NaFePO₄, and the like are exemplified. Among these, from the viewpoint of the energy density, the compound represented by General Formula LiₓA_{y}D_{z}PO₄ (here, A represents at least one element selected from the group consisting of Co, Mn, Ni, Fe, Cu, and Cr, D represents at least one element selected from the group consisting of Mg, Ca, Sr, Ba, Ti, Zn, B, Al, Ga, In, Si, Ge, Sc, and Y, 0.9<x<1.1, 0<y≤1, 0≤z<1, and 0.9<y+z<1.1) is preferred.

LiₓA_{y}D_{z}PO₄ is preferably an electrode active material satisfying 0.9<x<1.1, 0<y≤1, 0≤z<1, and 0.9<y+z<1.1 from the viewpoint of a high discharge capacity and a high energy density.

A crystallite diameter of the olivine-type electrode active material is preferably 30 nm or more and 150 nm or less and more preferably 50 nm or more and 120 nm or less.

When the crystallite diameter of the olivine-type electrode active material is less than 30 nm, a large amount of carbon is required to sufficiently coat a surface of the electrode active material with the carbonaceous film, and a large amount of the binding agent is required, and thus a mass of the electrode active material in the electrode decreases, and there is a case in which the capacity of the battery decreases. Similarly, there is a case in which the carbonaceous film peels off due to the lack of a binding force. Meanwhile, when the crystallite diameter of the olivine-type electrode active material exceeds 150 nm, an internal resistance of the electrode active material increases, and there is a case in which the discharge capacity at a high charge-discharge rate is decreased in the case of forming a battery.

The crystallite diameter of the olivine-type electrode active material is calculated from the Scherrer equation using a full width at half maximum of a diffraction peak of a (020) plane in a powder X-ray diffraction pattern that is measured by X-ray diffraction measurement and a diffraction angle (2θ).

“Carbonaceous Film”

The carbonaceous film is a pyrolytic carbonaceous film obtained by carbonizing an organic compound that serves as a raw material. A source of carbon that serves as a raw material of the carbonaceous film is preferably derived from an organic compound having a purity of carbon of 42.00% or more and 60.00% or less.

As a method for calculating “the purity of carbon” of the source of carbon that serves as a raw material of the carbonaceous film in the electrode material for a lithium ion secondary battery of the present embodiment, in a case of a plurality of kinds of organic compounds is used, a method in which amounts (% by mass) of carbon in amounts of the respective organic compounds blended are calculated and summed from the amounts (% by mass) of the respective organic compounds blended and a well-known purity (%) of carbon and the purity of carbon is calculated according to Expression (4) using a total amount (% by mass) of the organic compounds blended and a total amount (% by mass) of carbon is used.

Purity (%) of carbon=total amount (% by mass) of carbon/total amount blended (% by mass)×100 (4)

According to the electrode material for a lithium ion secondary battery of the present embodiment, in an electrode material for a lithium ion secondary battery containing a granulated body granulated by primary particles which include an olivine-type electrode active material and a carbonaceous film that coats a surface of the olivine-type electrode active material, when an average particle diameter of the primary particles is 30 nm or more and 500 nm or less, an average particle diameter of the granulated body is 0.5 μm or more and 60 μm or less, a tensile strength σ of the granulated body is 4 MPa or more, and a brittleness of the granulated body that is defined as a ratio (σ/b) of the tensile strength σ of the granulated body to a compression constant b of the granulated body is set to 0.2 or more, it is possible to provide an electrode material for a lithium ion secondary battery having an improved compressive strength and an improved tensile strength. That is, according to the electrode material for a lithium ion secondary battery of the present embodiment, breakage of the electrode material for a lithium ion secondary battery is suppressed, and it is possible to prevent the peeling of the carbonaceous film that coats the surface of the olivine-type electrode active material. Therefore, according to the electrode material for a lithium ion secondary battery of the present embodiment, it is possible to provide an electrode for a lithium ion secondary battery having excellent electron conductivity.

[Method for Manufacturing Electrode Material for Lithium Ion Secondary Battery]

A method for manufacturing the electrode material for lithium ion secondary battery of the present embodiment is not particularly limited, and examples thereof include a method having a step of producing a dispersed body by mixing LiₓA_{y}D_{z}PO₄ particles and the organic compound and carrying out a dispersion treatment, a step of producing a dried body by drying this dispersed body, a step of obtaining a granulated body granulated by the primary particles of the carbonaceous coated electrode active material by calcinating the dried body in a non-oxidative atmosphere, and a step of mixing the obtained granulated body and the oxide-based electrode active material.

The LiₓA_{y}D_{z}PO₄ particles are not particularly limited, but are preferably particles obtained by, for example, injecting a Li source, an A source, a D source, and a PO₄ source into water so that a molar ratio therebetween reaches x:y+z=1:1, stirring the components to produce a precursor solution of LiₓA_{y}D_{z}PO₄, putting the precursor solution into a pressure resistant vessel, and carrying out a hydrothermal treatment at a high temperature and a high pressure, for example, at 120° C. or higher and 250° C. or lower at 0.2 MPa or more for one hour or longer and 24 hours or shorter.

In this case, particle diameters of the LiₓA_{y}D_{z}PO₄ particles can be controlled to a desired size by adjusting the temperature, a pressure, and the time during the hydrothermal treatment.

In this case, as the Li source, for example, at least one selected from the group of consisting of inorganic lithium acid salts such as lithium hydroxide (LiOH), lithium carbonate (Li₂CO₃), lithium chloride (Lin), and lithium phosphate (Li₃PO₄) and organic lithium acid salts such as lithium acetate (LiCH₃COO) and lithium oxalate ((COOLi)₂) is preferably used.

Among these, lithium chloride and lithium acetate are preferred since a uniform solution phase is easily obtained.

Here, as the A source, at least one selected from the group of a Co source made of a cobalt compound, a Mn source made of a manganese compound, a Ni source made of a nickel compound, a Fe source made of an iron compound, a Cu source made of a copper compound, and a Cr source made of a chromium compound is preferred. In addition, as the D source, at least one selected from the group of a Mg source made of a magnesium compound, a Ca source made of a calcium compound, a Sr source made of a strontium compound, a Ba source made of a barium compound, a Ti source made of a titanium compound, a Zn source made of a zinc compound, a B source made of a boron compound, an Al source made of an aluminum compound, a Ga source made of a gallium compound, an In source made of an indium compound, a Si source made of a silicon compound, a Ge source made of a germanium compound, a Sc source made of a scandium compound, and a Y source made of a yttrium compound is preferred.

As the Co source, a Co salt is preferred, and, for example, at least one selected from cobalt (II) chloride (CoCl₂), cobalt (II) sulfate (CoSO₄), cobalt (II) nitrate (Co(NO₃)₂), cobalt (II) acetate (Co(CH₃COO)₂), and hydrates thereof is preferably used.

As the Mn source, a Mn salt is preferred, and, for example, at least one selected from manganese (II) chloride (MnCl₂), manganese (II) sulfate (MnSO₄), manganese (II) nitrate (Mn(NO₃)₂), manganese (II) acetate (Mn(CH₃COO)₂), and hydrates thereof is preferably used. Among these, manganese sulfate is preferred since a uniform solution phase is easily obtained.

As the Ni source, a Ni salt is preferred, and, for example, at least one selected from nickel (II) chloride (NiCl₂), nickel (II) sulfate (NiSO₄), nickel (II) nitrate (Ni(NO₃)₂), nickel (II) acetate (Ni(CH₃COO)₂), and hydrates thereof is preferably used.

As the Fe source, for example, a divalent iron compound such as iron (III) chloride (FeCl₂), iron (II) sulfate (FeSO₄), or iron (III) acetate (Fe(CH₃COO)₂) and hydrates thereof, a trivalent iron compound such as iron (II) nitrate (Fe(NO₃)₃), iron (III) chloride (FeCl₃), or iron (II) citrate (FeC₆H₅O₇), lithium iron phosphate, or the like is used.

As the Cu source, for example, copper (II) chloride (CuCl₂), copper (II) sulfate (CuSO₄), copper (II) nitrate (Cu(NO₃)₂), copper (II) acetate (Cu₂(CH₃COO)₄), and hydrates thereof are exemplified, and at least one selected from the group consisting of the above-described compounds is preferred.

As the Cr source, for example, chromium (II) chloride (CrCl₂), chromium (III) sulfate (Cr₂(SO₄)₃), chromium (II) nitrate (Cr(NO₃)₃), chromium (II) acetate (Cr₂(CH₃COO)₄), and hydrates thereof are exemplified, and at least one selected from the group consisting of the above-described compounds is preferred.

As the Mg source, for example, magnesium (II) chloride (MgCl₂), magnesium (II) sulfate (MgSO₄), magnesium (II) nitrate (Mg(NO₃)₂), magnesium (II) acetate (Mg(CH₃COO)₂), and hydrates thereof are exemplified, and at least one selected from the group consisting of the above-described compounds is preferred.

As the Ca source, for example, calcium (II) chloride (CaCl₂), calcium (II) sulfate (CaSO₄), calcium (II) nitrate (Ca(NO₃)₂), calcium (II) acetate (Ca(CH₃COO)₂), and hydrates thereof are exemplified, and at least one selected from the group consisting of the above-described compounds is preferred.

As the Sr source, for example, strontium carbonate (SrCo₃), strontium sulfate (SrSO₄), and strontium hydroxide (Sr(OH)₂) are exemplified, and at least one selected from the group consisting of the above-described compounds is preferred.

As the Ba source, for example, barium (II) chloride (BaCl₂), barium (II) sulfate (BaSO₄), barium (II) nitrate (Ba(NO₃)₂), barium (II) acetate (Ba(CH₃COO)₂), and hydrates thereof are exemplified, and at least one selected from the group consisting of the above-described compounds is preferred.

As the Ti source, for example, titanium chloride (TiCl₄, TiCl₃, TiCl₂), titanium oxide (TiO), and hydrates thereof are exemplified, and at least one selected from the group consisting of the above-described compounds is preferred.

As the Zn source, a Zn salt is preferred, and for example, zinc (II) chloride (ZnCl₂), zinc (II) sulfate (ZnSO₄), zinc (II) nitrate (Zn(NO₃)₂), zinc (II) acetate (Zn(CH₃COO)₂), and hydrates thereof are exemplified, and at least one selected from the group consisting of the above-described compounds is preferred.

As the B source, for example, boron compounds such as a chloride, a sulfoxide, a nitroxide, an acetoxide, a hydroxide, and an oxide are exemplified, and at least one selected from the group consisting of the above-described compounds is preferred.

As the Al source, for example, aluminum compounds such as a chloride, a sulfoxide, a nitroxide, an acetoxide, and a hydroxide are exemplified, and at least one selected from the group consisting of the above-described compounds is preferred.

As the Ga source, for example, gallium compounds such as a chloride, a sulfoxide, a nitroxide, an acetoxide, and a hydroxide are exemplified, and at least one selected from the group consisting of the above-described compounds is preferred.

As the In source, for example, indium compounds such as a chloride, a sulfoxide, a nitroxide, an acetoxide, and a hydroxide are exemplified, and at least one selected from the group consisting of the above-described compounds is preferred.

As the Si source, for example, sodium silicate, potassium silicate, silicon tetrachloride (SiCl₄), silicate, organic silicon compounds, and the like are exemplified, and at least one selected from the group consisting of the above-described compounds is preferred.

As the Ge source, for example, germanium compounds such as a chloride, a sulfoxide, a nitroxide, an acetoxide, a hydroxide, and an oxide are exemplified, and at least one selected from the group consisting of the above-described compounds is preferred.

As the Sc source, for example, scandium compounds such as a chloride, a sulfoxide, a nitroxide, an acetoxide, a hydroxide, and an oxide are exemplified, and at least one selected from the group consisting of the above-described compounds is preferred.

As the Y source, for example, yttrium compounds such as a chloride, a sulfoxide, a nitroxide, an acetoxide, a hydroxide, and an oxide are exemplified, and at least one selected from the group consisting of the above-described compounds is preferred.

As the PO₄ source, for example, at least one selected from phosphoric acid such as orthophosphoric acid (H₃PO₄) and metaphosphoric acid (HPO₃), ammonium dihydrogen phosphate (NH₄H₂PO₄), diammonium hydrogen phosphate ((NH₄)₂HPO₄), ammonium phosphate ((NH₄)₃PO₄), lithium phosphate (Li₃PO₄), dilithium hydrogen phosphate (Li₂HPO₄), lithium dihydrogen phosphate (LiH₂PO₄) and hydrate thereof is preferred. Particularly, orthophosphoric acid is preferred since a uniform solution phase is easily formed.

LiFePO₄ precursor particles refer to a state in which a liquid mixture containing the Li source, the Fe source, the PO₄ source, and water is thermally treated at a low temperature at which LiFePO₄ particles are not formed.

The above-described LiFePO₄ precursor particles are obtained by injecting the Li source, the Fe source, and the PO₄ source into water so that a molar ratio therebetween reaches 1:1:1, stirring the components to produce a precursor solution of LiFePO₄ particles, and heating the precursor solution at 60° C. or higher and 90° C. or lower for one hour or longer and 24 hours or shorter.

The reasons for the production of the above-described LiFePO₄ precursor particles being preferable are as described below.

When the LiFePO₄ precursor particles are mixed with the LiₓA_{y}D_{z}PO₄ particles in a state in which no thermal treatment is carried out, the Li source, the Fe source, and the PO₄ source are uniformly present on the surfaces of the particles, and thus the uniform formation of the carbonaceous film becomes easy.

Meanwhile, when a thermal treatment is carried out at a temperature high enough for the formation of the LiₓA_{y}D_{z}PO₄ particles, it becomes difficult for Fe to attach to the LiₓA_{y}D_{z}PO₄ particles in a state of the LiFePO₄ particles, and thus it becomes impossible to cause a desired amount of Fe to be present on the surfaces of the LiₓA_{y}D_{z}PO₄ particles.

Examples of the organic compound include polyvinyl alcohol, polyvinyl pyrrolidone, cellulose, starch, gelatin, carboxymethyl cellulose, methyl cellulose, hydroxymethyl cellulose, hydroxyethyl cellulose, polyacrylic acid, polystyrene sulfonate, polyacrylamide, polyvinyl acetate, glucose, fructose, galactose, mannose, maltose, sucrose, lactose, glycogen, pectin, alginic acid, glucomannan, chitin, hyaluronic acid, chondroitin, agarose, polyethers, polyvalent alcohols, and the like.

Examples of the polyvalent alcohols include polyethylene glycol, polypropylene glycol, polyglycerin, glycerin, and the like.

The organic compound needs to be mixed so that a content of carbon in the organic compound reaches 0.5 parts by mass or more and 2.5 parts by mass or less with respect to 100 parts by mass of the LiₓA_{y}D_{z}PO₄ particles.

Next, the obtained liquid mixture is dispersed, thereby producing a dispersed body.

A dispersion method is not particularly limited, but a device capable of imparting a dispersion energy large enough to disentangle an agglomerated state of the LiₓA_{y}D_{z}PO₄ particles and cause the LiFePO₄ precursor particles to be scattered and attached to the surfaces of the respective LiₓA_{y}D_{z}PO₄ particles is preferably used. Examples of the above-described dispersion device include a ball mill, a sand mill, a planetary (sun-and-planet-type) mixer, and the like.

Next, the dispersed body is dried, thereby producing a dried body.

In the present step, a drying method is not particularly limited as long as it is possible to dissipate a solvent (water) from the dispersed body.

Meanwhile, in the case of producing agglomerated particles, the dispersed body may be dried using a spray decomposition method. Examples thereof include a method in which the dispersed body is sprayed and dried in a high-temperature atmosphere of 100° C. or higher and 300° C. or lower, thereby producing a particulate dried body or a granular dried body.

Next, the dried body is calcinated in a non-oxidative atmosphere at a temperature in a range of 700° C. or higher and 1,000° C. or lower and preferably 800° C. or higher and 900° C. or lower.

The non-oxidative atmosphere is preferably an inert atmosphere of nitrogen (N₂), argon (Ar), or the like, and, in a case in which oxidation needs to be further suppressed, a reducing atmosphere including a reducing gas such as hydrogen (H₂) is preferred.

Here, the reasons for setting the calcination temperature of the dried body to 700° C. or higher and 1,000° C. or lower are as described below. When the calcination temperature is lower than 700° C., the decomposition and reaction of the organic compound included in the dried body do not sufficiently proceed, the carbonization of the organic compound becomes insufficient, and a decomposed and reacted substance to be generated becomes a high-resistance organic substance decomposed substance, which is not preferable. Meanwhile, when the calcination temperature exceeds 1,000° C., a component constituting the dried body, for example, lithium (Li) evaporate and thus the composition changes, and, furthermore, grain growth is accelerated in the dried body, the discharge capacity at a high charge-discharge rate decreases, and it becomes difficult to realize a sufficient charge and discharge rate performance, which is not preferable.

A calcination time is not particularly limited as long as the time is long enough for the sufficient carbonization of the organic compound and is set to 0.1 hours or longer and 10 hours or shorter.

Due to this calcination, a granulated body granulated by the primary particles of the carbonaceous coated electrode active material is obtained.

Next, the obtained granulated body and the oxide-based electrode active material are mixed together in a predetermined ratio, thereby obtaining the electrode material for a lithium ion secondary battery of the present embodiment.

A method for mixing the granulated body and the oxide-based electrode active material is not particularly limited, but a device capable of uniformly mixing the granulated body and the oxide-based electrode active material is preferably used. Examples of the above-described device include a ball mill, a sand mill, a planetary (sun-and-planet-type) mixer, and the like.

[Cathode for a Lithium Ion Secondary Battery]

An electrode for a lithium ion secondary battery of the present embodiment is an electrode for a lithium ion secondary battery including an electrode current collector and an electrode mixture layer (electrode) formed on the electrode current collector, in which the electrode mixture layer contains the electrode material for a lithium ion secondary battery of the present embodiment.

That is, the electrode for a lithium ion secondary battery of the present embodiment is an electrode for a lithium ion secondary battery obtained by forming the electrode mixture layer on one main surface of the electrode current collector using the electrode material for a lithium ion secondary battery of the present embodiment.

A method for manufacturing the electrode for a lithium ion secondary battery of the present embodiment is not particularly limited as long as the electrode can be formed on one main surface of the electrode current collector using the electrode material for a lithium ion secondary battery of the present embodiment. As the method for manufacturing the electrode for a lithium ion secondary battery of the present embodiment, for example, the following method is exemplified.

First, an electrode material paste for a lithium ion secondary battery is prepared by mixing the electrode material for a lithium ion secondary battery of the present embodiment, a binding agent, a conductive auxiliary agent, and a solvent.

“Binding Agent”

The binding agent is not particularly limited as long as the binding agent can be used in a water system. For example, at least one selected from the group of polyethylene, polypropylene, polyethylene terephthalate, polymethyl methacrylate, vinyl acetate copolymers, styrene⋅butadiene-based latex, acrylic latex, acrylonitrile⋅butadiene-based latex, fluorine-based latex, silicone-based latex, and the like is exemplified.

A content rate of the binding agent in the electrode material paste for a lithium ion secondary battery is preferably 1% by mass or more and 10% by mass or less and more preferably 2% by mass or more and 6% by mass or less in a case in which a total mass of the electrode material for a lithium ion secondary battery of the present embodiment, the binding agent, and the conductive auxiliary agent is set to 100% by mass.

“Conductive Auxiliary Agent”

The conductive auxiliary agent is not particularly limited, and, for example, at least one selected from a group of fibrous carbon such as acetylene black, ketjen black, furnace black, vapor grown carbon fiber (VGCF), and carbon nanotube is used.

A content rate of the conductive auxiliary agent in the electrode material paste for a lithium ion secondary battery is preferably 1% by mass or more and 15% by mass or less and more preferably 3% by mass or more and 10% by mass or less in a case in which the total mass of the electrode material for a lithium ion secondary battery of the present embodiment, the binding agent, and the conductive auxiliary agent is set to 100% by mass.

“Solvent”

To the electrode material for a lithium ion secondary battery including the electrode material for a lithium ion secondary battery of the present embodiment, a solvent may be appropriately added in order to facilitate the application to an application target such as the current collector.

A main solvent is water, but the electrode material paste for a lithium ion secondary battery may contain a water-based solvent such as an alcohol, a glycol, or an ether as long as the characteristics of the electrode material for a lithium ion secondary battery of the present embodiment are not lost.

A content rate of the solvent in the electrode material paste for a lithium ion secondary battery is preferably 60 parts by mass or more and 400 parts by mass or less and more preferably 80 parts by mass or more and 300 parts by mass or less in a case in which a total mass of the electrode material for a lithium ion secondary battery of the present embodiment, the binding agent, and the solvent is set to 100 parts by mass.

When the electrode material paste for a lithium ion secondary battery contains the solvent in the above-described range, it is possible to obtain an electrode material paste for a lithium ion secondary battery having an excellent electrode-forming property and excellent battery characteristics.

A method for mixing the electrode material for a lithium ion secondary battery of the present embodiment, the binding agent, the conductive auxiliary agent, and the solvent is not particularly limited as long as these components can be uniformly mixed together. Examples thereof include methods in which a kneader such as a ball mill, a sand mill, a planetary (sun-and-planet-type) mixer, a paint shaker, or a homogenizer is used.

Next, the electrode material paste for a lithium ion secondary battery is applied onto one main surface of the electrode current collector to form a coated film, and this coated film is dried and bonded by pressurization, whereby an electrode for a lithium ion secondary battery in which the electrode mixture layer is formed on one main surface of the electrode current collector can be obtained.

According to the electrode for a lithium ion secondary battery of the present embodiment, the electrode material for a lithium ion secondary battery of the present embodiment is contained, and thus it is possible to provide an electrode for a lithium ion secondary battery having excellent electron conductivity.

[Lithium Ion Secondary Battery]

A lithium ion secondary battery of the present embodiment includes a cathode made of the electrode for a lithium ion secondary battery of the present embodiment, an anode, a separator, and an electrolyte.

In the lithium ion secondary battery of the present embodiment, the anode, the electrolyte, the separator, and the like are not particularly limited.

As the anode, for example, an anode material such as metallic Li, a carbon material, a Li alloy, or Li₄Ti₅O₁₂ can be used.

In addition, instead of the electrolyte and the separator, a solid electrolyte may be used.

The electrolyte can be produced by, for example, mixing ethylene carbonate (EC) and ethyl methyl carbonate (EMC) so that a volume ratio therebetween reached 1:1 and dissolving a lithium hexafluorophosphate (LiPF₆) in the obtained solvent mixture so that a concentration reaches, for example, 1 mol/dm³.

As the separator, for example, porous propylene can be used.

In the lithium ion secondary battery of the present embodiment, the electrode for a lithium ion secondary battery of the present embodiment is used, and thus it is possible to provide a lithium ion secondary battery having a large discharge capacity.

### EXAMPLES

Hereinafter, the present invention will be more specifically described using examples and comparative examples, but the present invention is not limited to the following examples.

### Manufacturing Example 1

“Manufacturing of Electrode Active Material (LiFePO₄)”

Lithium hydroxide (LiOH) as a Li source, ammonium dihydrogen phosphate (NH₄H₂PO₄) as a P source, and iron (II) sulfate heptahydrate (FeSO₄.7H₂O) as a Fe source (A source) were used.

Lithium hydroxide, ammonium dihydrogen phosphate), and iron (II) sulfate heptahydrate were mixed into water so that a mass ratio (Li:Fe:P) reached 3:1:1 and a total amount reached 200 mL, thereby preparing a homogeneous slurry-form mixture.

Next, this mixture was stored in a pressure-resistant airtight container having a capacity of 500 mL and was hydrothermally synthesized at 170° C. for 12 hours.

After this reaction, the reaction liquid was cooled to room temperature (25° C.), thereby obtaining a cake-form reaction product which was sedimented.

Next, this sediment (reaction product) was sufficiently cleaned with distilled water a plurality of times, and a water content ratio was maintained at 30% while adding pure water thereto so as to prevent the sediment from being dried, thereby producing a cake-form substance.

As a result of analyzing a powder obtained by sampling a small amount of this cake-form substance and drying the cake-form substance in a vacuum at 70° C. for two hours by means of X-ray diffraction measurement (X-ray diffractormeter: RINT2000, manufactured by Rigaku Corporation), it was confirmed that single-phase LiFePO₄ was formed.

### Manufacturing Example 2

“Manufacturing of Electrode Active Material (LiMnPO₄)”

LiMnPO₄ was synthesized in the same manner as in Manufacturing Example 1 except for the fact that manganese (II) sulfate monohydrate (MnSO₄.H₂O) was used instead of iron (II) sulfate heptahydrate (FeSO₄.7H₂O) as the A source.

### Manufacturing Example 3

“Manufacturing of Electrode Active Material (Li[Fe_{0.25}Mn_{0.75}]PO₄)”

Li[Fe_{0.25}Mn_{0.75}]PO₄ was synthesized in the same manner as in Manufacturing Example 1 except for the fact that a mixture of FeSO₄.7H₂O and MnSO₄.H₂O (at a mass ratio (FeSO₄.7H₂O to MnSO₄.H₂O) of 25:75) was used as the A source.

### Manufacturing Example 4

“Manufacturing of Electrode Active Material (NaFePO₄)”

NaFePO₄ was synthesized in the same manner as in Manufacturing Example 1 except for the fact lithium hydroxide (NaOH) was used as the Li source.

### Example 1

LiFePO₄ (electrode active material) (20 g) obtained in Manufacturing Example 1, polyethylene glycol (0.6 g) as an organic compound, pure water, and zirconia balls having a diameter of 0.1 mm as medium particles were added, and a dispersion treatment was carried out in a sand mill, thereby preparing a homogeneous slurry. At this time, an amount of the pure water was adjusted so that a proportion of a mass of the slurry as a denominator in a mass of the electrode active material as a numerator reached 0.5. In addition, a median diameter in a particle size distribution of the slurry after the dispersion treatment by the sand mill was adjusted to 100 nm, and a point at which a median diameter (nm)/crystallite diameter (nm) that was calculated from the crystallite diameter before the dispersion treatment by the sand mill of 91 nm reached 1.10 was considered as an end point of the sand mill dispersion.

Next, the obtained slurry was dried and granulated using a spray dryer at a temperature at which a drying outlet temperature reached 60° C.

After that, the obtained granulated body was heated in a nitrogen (N₂) atmosphere at a temperature-increase rate of 20° C./minute and thermally treated at a temperature of 770° C. for four hours, thereby obtaining an electrode material of Example 1 made of a granulated body granulated by primary particles of a carbonaceous coated electrode active material.

### Example 2

An electrode material of Example 2 was obtained in the same manner as in Example 1 except for the fact that glucose (1.2 g) was used instead of polyethylene glycol.

### Example 3

An electrode material of Example 3 was obtained in the same manner as in Example 2 except for the fact that the median diameter in the particle size distribution of the slurry after the dispersion treatment by the sand mill was adjusted to 98 nm, and the point at which the median diameter (nm)/crystallite diameter (nm) that was calculated from the crystallite diameter before the dispersion treatment by the sand mill of 123 nm reached 1.07 was considered as the end point of the sand mill dispersion.

### Example 4

A dispersion treatment was carried out in a sand mill using LiMnPO₄ (19 g) obtained in Manufacturing Example 2, as a carbonization catalyst, lithium carbonate, iron (II) acetate, and phosphoric acid (Li:Fe:P=1:1:1 (mass ratio)) which corresponded to LiFePO₄ (1 g), glucose (1.4 g), and, as medium particles, zirconia balls having a diameter of 0.1 mm. At this time, the amount of the pure water was adjusted so that the proportion of the mass of the slurry as the denominator in the mass of the electrode active material as the numerator reached 0.5. In addition, the median diameter in the particle size distribution of the slurry after the dispersion treatment by the sand mill was adjusted to 83 nm, and the point at which the median diameter (nm)/crystallite diameter (nm) that was calculated from the crystallite diameter before the dispersion treatment by the sand mill of 76 nm reached 1.09 was considered as the end point of the sand mill dispersion.

Next, the obtained slurry was dried and granulated using the spray dryer at a temperature at which a drying outlet temperature reached 60° C.

After that, the obtained granulated body was heated in a nitrogen (N₂) atmosphere at a temperature-increase rate of 20° C./minute and thermally treated at a temperature of 770° C. for four hours, thereby obtaining an electrode material of Example 4 granulated by primary particles of a carbonaceous coated electrode active material.

### Example 5

A dispersion treatment was carried out in a sand mill using Li[Fe_{0.25}Mn_{0.75}]PO₄ (19 g) obtained in Manufacturing Example 3, as a carbonization catalyst, lithium carbonate, iron (II) acetate, and phosphoric acid (Li:Fe:P=1:1:1 (mass ratio)) which corresponded to LiFePO₄ (1 g), glucose (1.4 g), and, as medium particles, zirconia balls having a diameter of 0.1 mm. At this time, the amount of the pure water was adjusted so that the proportion of the mass of the slurry as the denominator in the mass of the electrode active material as the numerator reached 0.5. In addition, the median diameter in the particle size distribution of the slurry after the dispersion treatment by the sand mill was adjusted to 95 nm, and the point at which the median diameter (nm)/crystallite diameter (nm) that was calculated from the crystallite diameter before the dispersion treatment by the sand mill of 87 nm reached 1.09 was considered as the end point of the sand mill dispersion.

Next, the obtained slurry was dried and granulated using the spray dryer at a temperature at which a drying outlet temperature reached 60° C.

After that, the obtained granulated body was heated in a nitrogen (N₂) atmosphere at a temperature-increase rate of 20° C./minute and thermally treated at a temperature of 770° C. for four hours, thereby obtaining an electrode material of Example 5 granulated by primary particles of a carbonaceous coated electrode active material.

### Comparative Example 1

An electrode material of Comparative Example 1 was obtained in the same manner as in Example 1 except for the fact that an amount of the polyethylene glycol was set to 2.19 g and a thermal treatment temperature of the granulated body was set to 850° C.

### Comparative Example 2

An electrode material of Comparative Example 2 was obtained in the same manner as in Example 1 except for the fact that the organic compound was not added to the slurry and was stirred and mixed as a powder dried by a spray dryer.

### Comparative Example 3

An electrode material of Comparative Example 3 was obtained in the same manner as in Example 1 except for the fact that the drying outlet temperature of the spray dryer was set to 120° C.

### Comparative Example 4

An electrode material of Comparative Example 4 was obtained in the same manner as in Example 1 except for the fact that the electrode material obtained in Manufacturing Example 4 was used.

[Production of Lithium Ion Battery]

The electrode material obtained in each of Example 1 to Example 5 and Comparative Example 1 to Comparative Example 4, polyvinylidene fluoride (PVdF) as a binding material, and acetylene black (AB) as a conductive auxiliary agent were added to N-methyl-2-pyrrolidone (NMP) so that a mass ratio in a paste reached 90:5:5 (electrode material:AB:PVdF) and mixed together, thereby preparing a cathode material paste (for a cathode).

Next, this cathode material paste was applied on a surface of a 30 μm-thick aluminum foil (electrode current collector) to form a coated film, this coated film was dried, a cathode mixture layer was formed on a surface of the aluminum foil, and then the cathode mixture layer was bonded by pressurization so as to obtain a predetermined density, thereby producing an electrode plate for a cathode.

A plate-like specimen made up of a 3 cm×3 cm square (electrode area: 9 cm²) cathode mixture layer and a space for a tab was obtained from the obtained electrode plate by means of punching using a molder.

Next, an electrode tap was welded to the space for a tap of the electrode plate, thereby producing a test electrode (cathode).

Lithium titanate (Li₄Ti₅O₁₂), polyvinylidene fluoride (PVdF) as a binding material, and acetylene black (AB) as a conductive auxiliary agent were added to N-methyl-2-pyrrolidone (NMP) so that a mass ratio in a paste reached 90:5:5 (lithium titanate:AB:PVdF) and mixed together, thereby preparing an anode material paste (for an anode).

Next, this anode material paste was applied on a surface of a 30 μm-thick aluminum foil (electrode current collector) to form a coated film, this coated film was dried, an anode mixture layer was formed on the surface of the aluminum foil, and then the anode mixture layer was bonded by pressurization so as to obtain a predetermined density, thereby producing an electrode plate for an anode.

A plate-like specimen made up of a 3 cm×3 cm square (electrode area: 9 cm²) anode mixture layer and a space for a tab was obtained from the obtained electrode plate by means of punching using a molder.

Next, an electrode tap was welded to the space for a tap of the electrode plate, thereby producing an anode.

The produced cathode and anode were caused to face each other through a 20 μm-thick separator made of porous polypropylene, immersed in a solution (0.5 mL) of 1 mol/L of lithium hexafluorophosphate (LiPF₆) as a non-aqueous electrolyte (non-aqueous electrolyte solution), and then sealed with a laminate film, thereby producing a lithium ion secondary battery.

As the LiPF₆ solution, a solution obtained by mixing ethylene carbonate and ethyl methyl carbonate so that a volume ratio reached 1:1 and adding 2% vinylene carbonate thereto as an additive was used.

[Evaluation of Electrode Materials]

The electrode materials obtained in Example 1 to Example 5 and Comparative Example 1 to Comparative Example 4 and the components included in the electrode materials were evaluated. Evaluation methods are as described below. The results are shown in Table 1.

(1) Crystallite Diameter of Electrode Active Material

The crystallite diameter of the electrode active material was calculated from the Scherrer equation using a full width at half maximum of a diffraction peak of a (020) plane in a powder X-ray diffraction pattern that was measured by means of X-ray diffraction measurement (X-ray diffractormeter: RINT2000 (trade name), manufactured by Rigaku Corporation) and a diffraction angle (20).

(2) Average Particle Diameter of Primary Particles of Carbonaceous Coated Electrode Active Material

The average particle diameter of the primary particles of the carbonaceous coated electrode active material was obtained by number-averaging the particle diameters of 200 or more primary particles randomly measured by scanning electron microscopic (SEM) observation.

(3) Content of Carbon in Electrode Material

The content of carbon (% by mass) in the electrode material was measured using a carbon analyzer (manufactured by Horiba Ltd., carbon/sulfur combustion analyzer EMIA-810W (trade name)).

(4) Specific Surface Area of Electrode Material

The specific surface area of the electrode material was measured using a BET method by means of nitrogen (N₂) adsorption and a specific surface area meter (trade name: BELSORP-mini, manufactured by MicrotracBEL Corp.).

(5) NMP Oil Absorption Amount of Electrode Material

The NMP oil absorption amount of the electrode material was measured according to Japanese Industrial Standards JIS K5101-13-1:2004 (Test methods for pigments-Part 13: Oil absorption-Section 1: Refined linseed oil method) except for the fact that N-methyl-2-pyrrolidone (NMP) was used instead of linseed oil.

(6) Green Compact Resistance of Electrode Material

The electrode material was injected into a mold and molded at a pressure of 50 MPa, thereby producing a specimen. The powder resistivity (Ω·cm) of the specimen was measured using a low resistivity meter (manufactured by Mitsubishi Chemical Corporation, trade name: Loresta-GP) by four point measurements at 25° C.

(7) Average Particle Diameter of Granulated Body (Secondary Particles)

The average particle diameter of the granulated body (secondary particles) was measured using a laser diffraction/scattering particle size distribution analyzer (trade name: LA-950V2, manufactured by Horiba Ltd.) by suspending the electrode material in a dispersion medium obtained by dissolving 0.1% by mass of polyvinyl pyrrolidone in water.

(8) Fracture Strain of Electrode Material

A fracture strain of the electrode material was measured with reference to a reference (Noriyuki Yamada, Chapters 3 and 4, Study regarding preparation and evaluation of functional particles by a spray drying method, Kyushu University).

The particle diameter of the electrode material was measured in a microscope using a micro compression tester (trade name: MCT510, manufactured by Shimadzu Corporation), and then a fracture strain of the electrode material was measured in a compression test mode under conditions of a kind of an indenter: FLAT50, a load rate: 0.0446 mN/sec, and a testing force: 9.8 mN. Meanwhile, in the measurement of the fracture strain of the electrode material, five specimens of the electrode material were randomly selected as specimens, an average value of strain was calculated from particle diameters of the five specimens and a variation of the particle diameters when the granulated bodies fracture, and the obtained value was considered as the fracture strain.

(9) Ratio of Tensile Strength to Compression Constant of Electrode Material

A ratio of a tensile strength to a compression constant of the electrode material was measured with reference to a reference (Noriyuki Yamada, Chapters 3 and 4, Study regarding preparation and evaluation of functional particles by a spray drying method, Kyushu University).

3 g of the granulated body was injected into a mold (a recess portion having a circular shape with a diameter of 2 cm in the case of being seen in a plane), a pressure was applied thereto at intervals of 0.5 MPa, and a total of the pressure applied up to 3.0 MPa and a volume change in the electrode material were measured. That is, the pressure being applied was increased at 0.5 MPa intervals such as 0 MPa, 0.5 MPa, 1.0 MPa, 1.5 MPa, 2.0 MPa, 2.5 MPa, and 3.0 MPa, and volumes at the respective pressures were measured.

On the basis of the measurement results of the pressure and the volume change of the electrode material, the tensile strength and the brittleness of the granulated body were calculated using Expressions (11) to (17).

In Expressions (11) to (17), V₀ represents a volume (m³) of the electrode material before compression, V represents the volume (m³) of the electrode material under compression, Vₘ represents the volume (a volume with a porosity of zero and equivalent to a true specific weight) (m³) of the electrode material itself, P represents a compressive pressure (MPa), yc represents the fracture strain of the granulated body, ε₀ represents a porosity before compression, ε represents a porosity under compression, ε_{c} represents a porosity under compression, σ represents the tensile strength (MPa), b represents a compression constant (MPa), and C represents the brittleness (C=σ/b). In addition, a slope when Xa is plotted along a horizontal axis and Y is plotted along a vertical axis is σ/0.9, and the slope when Xb is plotted along the horizontal axis and Y is plotted along the vertical axis is b.

ε₀=1−Vₘ/V₀ (11)

ε=1−Vₘ/V (12)

ε_{c}=1−1/(1−yc)3×(1−ε₀) (13)

C=σ/b (14)

Xa=(ε₀−ε)/(ε₀−ε₀) (15)

Xb=(V₀−V)/Vₘ (16)

Y=P(V−Vₘ)/Vₘ (17)

[Evaluation of Electrodes and Lithium Ion Secondary Batteries]

Discharge capacities and direct current resistances (DCR) of charging and discharging were measured using the lithium ion secondary batteries obtained in Examples 1 to 5 and Comparative Examples 1 to 4. Evaluation methods are as described below. The results are shown in Table 1.

(1) Discharge Capacity

The discharge capacities of lithium ion secondary batteries were measured at an ambient temperature of 0° C. by means of constant-current charging and discharging with a cut-off voltage set to 1 V to 2 V, a charge current set to 1 C, and a discharge current set to 3 C.

(2) Direct Current Resistance (DCR) of Charging and Discharging

The lithium ion secondary batteries were charged with a current of 0.1 C at an ambient temperature of 0° C. for five hours, and the depths of charge were adjusted (state of charge (SOC) 50%). On the batteries adjusted to SOC 50%, “1 C charging for 10 seconds→10-minute rest→1 C discharging for 10 seconds→10-minute rest” as a first cycle, “3 C charging for 10 seconds→10-minute rest→3 C discharging for 10 seconds→10-minute rest” as a second cycle, “5 C charging for 10 seconds→10-minute rest→5 C discharging for 10 seconds→10-minute rest” as a third cycle, and “10 C charging for 10 seconds→10-minute rest→10 C discharging for 10 seconds→10-minute rest” as a fourth cycle were sequentially carried out. Voltages 10 seconds after the respective charging and discharging during the cycles were measured. Individual current values were plotted along the horizontal axis, and the voltages after 10 seconds were plotted along the vertical axis, thereby drawing approximate straight lines. The slopes of the approximate straight lines were respectively considered as direct current resistances during charging (charging DCR) and direct current resistances during discharging (discharging DCR).

TABLE 1

| | | Average particle | | | | |
|---|---|---|---|---|---|---|
| | | diameter of secondary | | | | |
| | | particles of | Average particle | Content of carbon in | Specific surface area | |
| | | carbonaceous coated | diameter of primary | carbonaceous coated | of carbonaceous | |
| | | electrode active | particles of | electrode active | coated electrode | Crystallite |
| | Electrode active | material | electrode active | material | active material | diameter B |
| | material | (μm) | material (nm) | (% by mass) | (m²/g) | (nm) |
| Example 1 | LiFePO₄ | 8.9 | 110 | 1.0 | 15.2 | 88 |
| Example 2 | LiFePO₄ | 6.5 | 110 | 1.0 | 15.3 | 105 |
| Example 3 | LiFePO₄ | 5.1 | 107 | 0.9 | 15.4 | 103 |
| Example 4 | LiMnPO₄ | 1.2 | 92 | 1.5 | 16.3 | 52 |
| Example 5 | Li[Fe_{0.25}Mn_{0.75}]P0₄ | 8.0 | 101 | 1.0 | 14 | 54 |
| Comparative | LiFePO₄ | 15.0 | 150 | 3.4 | 19.2 | 196 |
| Example 1 | | | | | | |
| Comparative | LiFePO₄ | 0.4 | 115 | 1.0 | 14.9 | 90 |
| Example 2 | | | | | | |
| Comparative | LiFePO₄ | 9.8 | 110 | 1.2 | 15.4 | 89 |
| Example 3 | | | | | | |
| Comparative | NaFePO₄ | 6.5 | 98 | 1.0 | 16 | 73 |
| Example 4 | | | | | | |

| | | | | | Green compact | | | |
|---|---|---|---|---|---|---|---|---|
| | | | | | resistance of | | | |
| | | Tensile | Compression | | electrode | 3 C discharge | | Discharging |
| | NMP oil absorption | strength σ | constant b | Brittleness | material | capacity | Charging DCR | DCR |
| | amount (ml/100 g) | (MPa) | (MPa) | σ/b | (Ωcm) | (mAh/g) | (Ω) | (Ω) |
| Example 1 | 39 | 5.7 | 25 | 0.23 | 278 | 132 | 2.6 | 2.0 |
| Example 2 | 43 | 5.4 | 21 | 0.26 | 250 | 126 | 2.6 | 2.1 |
| Example 3 | 48 | 5.0 | 23 | 0.22 | 274 | 125 | 2.6 | 2.1 |
| Example 4 | 49 | 4.6 | 23 | 0.20 | 770 | 105 | 2.9 | 2.6 |
| Example 5 | 46 | 5.3 | 22 | 0.24 | 350 | 112 | 2.5 | 2.4 |
| Comparative | 40 | 5.1 | 30 | 0.17 | 180 | 113 | 10.8 | 7.6 |
| Example 1 | | | | | | | | |
| Comparative | 38 | 8.5 | 30 | 0.28 | 263 | 95 | 3.0 | 2.8 |
| Example 2 | | | | | | | | |
| Comparative | 63 | 3.5 | 25 | 0.14 | 215 | 108 | 2.8 | 2.5 |
| Example 3 | | | | | | | | |
| Comparative | 42 | 4.7 | 20 | 0.24 | 350 | 82 | 4.5 | 4.0 |
| Example 4 | | | | | | | | |

From the results in Table 1, it was confirmed that, in the lithium ion secondary batteries of Example 1 to Example 5, the direct current resistance of charging and discharging was low, and the discharge capacity was large.

On the other hand, from the results in Table 1, it was confirmed that, in the lithium ion secondary batteries of Comparative Example 1 to Comparative Example 4, the direct current resistance of charging and discharging was high and the discharge capacity was small.

The electrode material for a lithium ion secondary battery of the present invention is an electrode material for a lithium ion secondary battery containing a granulated body granulated by primary particles which include an olivine-type electrode active material and a carbonaceous film that coats a surface of the olivine-type electrode active material, in which an average particle diameter of the primary particles is 30 nm or more and 500 nm or less, an average particle diameter of the granulated body is 0.5 μm or more and 60 μm or less, a tensile strength σ of the granulated body is 4 MPa or more, and a brittleness of the granulated body that is defined as a ratio (σ/b) of the tensile strength σ of the granulated body to a compression constant b of the granulated body is 0.2 or more, and thus an electrode for a lithium ion secondary battery produced using this electrode material for a lithium ion secondary battery has excellent electron conductivity. Therefore, in a lithium ion secondary battery including this electrode for a lithium ion secondary battery, the direct current resistance of charging and discharging is low, and the discharge capacity increases, and thus the lithium ion secondary battery can also be applied to next-generation secondary batteries from which a high voltage, a higher energy density, higher load characteristics, and higher-rate charge and discharge characteristics are anticipated, and, in the case of a next-generation secondary battery, an effect thereof is extremely significant.

By the present invention, an electrode material for a lithium ion secondary battery having an improved compressive strength and an improved tensile strength, an electrode for a lithium ion secondary battery containing the electrode material for a lithium ion secondary battery, and a lithium ion secondary battery including the electrode for a lithium ion secondary battery can be provided.

1. An electrode material for a lithium ion secondary battery comprising:
a granulated body which is generated from primary particles,
wherein the primary particles include an olivine-type electrode active material and a carbonaceous film that coats a surface of the olivine-type electrode active material,
wherein an average particle diameter of the primary particles is 30 nm or more and 500 nm or less,
an average particle diameter of the granulated body is 0.5 μm or more and 60 μm or less, and
a tensile strength σ of the granulated body is 4 MPa or more, and
a brittleness of the granulated body that is defined as a ratio (σ/b) of the tensile strength σ of the granulated body to a compression constant b of the granulated body is 0.2 or more.

2. The electrode material for a lithium ion secondary battery according to claim 1,
wherein the olivine-type electrode active material is represented by General Formula LiₓA_{y}D_{z}PO₄ (here, A represents at least one element selected from the group consisting of Co, Mn, Ni, Fe, Cu, and Cr, D represents at least one element selected from the group consisting of Mg, Ca, Sr, Ba, Ti, Zn, B, Al, Ga, In, Si, Ge, Sc, and Y, 0.9<x<1.1, 0<y≤1, 0≤z<1, and 0.9<y+z<1.1).

3. The electrode material for a lithium ion secondary battery according to claim 1,
wherein a content of carbon in the granulated body is 0.5% by mass or more and 2.5% by mass or less, a coating ratio of the carbonaceous film to the primary particles is 80% or more, and a film thickness of the carbonaceous film is 0.8 nm or more and 5.0 nm or less.

4. The electrode material for a lithium ion secondary battery according to claim 1,
wherein an oil absorption amount of the olivine-type electrode active material which is evaluated using N-methyl-2-pyrrolidone (NMP) is 50 ml/100 g or less.

5. An electrode for a lithium ion secondary battery comprising:
an electrode current collector; and
an electrode mixture layer formed on the electrode current collector,
wherein the electrode mixture layer contains the electrode material for a lithium ion secondary battery battery according to claim 1.

6. A lithium ion secondary battery comprising:
a cathode;
an anode; and
a non-aqueous electrolyte,
wherein the cathode is the electrode for a lithium ion secondary battery according to claim 5.

7. The electrode material for a lithium ion secondary battery according to claim 1,
wherein the electrode material consists of the granulated body, and
the granulated body consists of an aggregate, an assembly, or a gathering of the primary particles.
